(19) United States
(12) Patent Application Publication
(10) Pub. No.: US 2010/0316305 A1
(43) Pub. Date: Dec. 16, 2010

(54) SYSTEM AND METHOD FOR ESTIMATING A DIRECTION OF MOTION BLUR IN AN IMAGE

(76) Inventor: Li Hong, San Diego, CA (US)

Correspondence Address: Roeder & Broder LLP, 5560 Chelsea Avenue, La Jolla, CA, 92037, US

(21) Appl. No.: 12/867,480

(22) PCT Filed: Feb. 2, 2009
(86) PCT No.: PCT/US09/32836

§ 371 Date: Aug. 12, 2010

Related U.S. Application Data
(60) Provisional application No. 61/055,019, filed on May 21, 2008.

(51) Int. Cl. G06K 9/40

(52) U.S. Cl. 382/255

(57) ABSTRACT

A method for estimating a blur direction (20) of motion blur (16) in a blurred image (14) includes the steps of (i) blurring the blurred image (14) along a first test direction (360A) to create an artificially blurred first test image (362A); (ii) blurring the blurred image (14) along a first perpendicular test direction (364A) to create an artificially blurred first perpendicular test image (366A), the first perpendicular test direction (366A) being substantially perpendicular to the first test direction (362A); (iii) comparing the first test image (360A) with the blurred image (14) to determine a first blur difference between the first test image (360A) and the blurred image (14); (iv) comparing the first perpendicular test image (366A) with the blurred image (14) to determine a first perpendicular blur difference between the first perpendicular test image (366A) and the blurred image (14); and (v) determining a first pair difference between the first blur difference and the first perpendicular blur difference.

### BACKGROUND

Cameras are commonly used to capture an image of a scene that includes one or more objects. Unfortunately, some of the images are blurred. For example, movement of the camera and/or movement of the objects in the scene during the exposure time of the camera can cause motion blur in the image that is mainly in the direction of motion.

There exist a number of deconvolution methods for reducing blur in a blurry image. These methods require a point spread function (“PSF”), which describes the blur, to be known or automatically estimated. Typically, the methods that estimate the PSF require a good initial guess for certain blur parameters, such as blur direction.

### SUMMARY

The present invention is directed to a method and device for estimating a blur direction of motion blur in a blurred image. In one embodiment, the method includes the steps of (i) blurring the blurred image along a first test direction to create an artificially blurred first test image; (ii) blurring the blurred image along a first perpendicular test direction to create an artificially blurred first perpendicular test image, the first perpendicular test direction being perpendicular to the first test direction; (iii) comparing the first test image with the blurred image to determine a first blur difference between the first test image and the blurred image; (iv) comparing the first perpendicular test image with the blurred image to determine a first perpendicular blur difference between the first perpendicular test image and the blurred image; and (v) determining a first pair difference between the first blur difference and the first perpendicular blur difference.

In certain embodiments, the proposed method for estimating the blur direction is based on the concepts that (i) when artificial blur is applied to the blurred image in a test direction that is similar to the blur direction, the difference in the image appearance is relatively small, and minimum changes exist between the additionally blurred image and the original image; and (ii) when artificial blur is applied to the blurred image in a test direction that is perpendicular to the blur direction, the difference in the image appearance is relatively large, and maximum changes exist between the additionally blurred image and the original image.

Additionally, the method can include the steps of (i) blurring the blurred image along a second test direction to create an artificially blurred second test image, the second test direction being different than the first test direction; (ii) blurring the blurred image along a second perpendicular test direction to create an artificially blurred second perpendicular test image, the second perpendicular test direction being perpendicular to the second test direction; (iii) comparing the second test image with the blurred image to determine a second blur difference between the second test image and the blurred image; (iv) comparing the second perpendicular test image with the blurred image to determine a second perpendicular blur difference between the second perpendicular test image and the blurred image; and (v) determining a second pair difference between the second blur difference and the second perpendicular blur difference.

Moreover, the method can include the steps of (i) blurring the blurred image along a third test direction to create an artificially blurred third test image, the third test direction being different than the first test direction and the second test direction; (ii) blurring the blurred image along a third perpendicular test direction to create an artificially blurred third perpendicular test image, the third perpendicular test direction being perpendicular to the third test direction; (iii) comparing the third test image with the blurred image to determine a third blur difference between the third test image and the blurred image; (iv) comparing the third perpendicular test image with the blurred image to determine a third perpendicular blur difference between the third perpendicular test image and the blurred image; and (v) determining a third pair difference between the third blur difference and the third perpendicular blur difference.

As provided herein, the method can include comparing one or more of the pair differences to select the blur direction. For example, the method can include the step of comparing the first pair difference, the second pair difference, and the third pair different to estimate the blur direction. More specifically, the method includes the step of selecting one of the first test directions as the blur direction in the event the first pair difference is greater than the second pair difference and the third pair difference.

The present invention is also directed to a device for estimating a blur direction of motion blur in a blurred image. In this embodiment, the control system can perform some or all of the steps described above.

In yet another embodiment, the present invention is directed to a method and device for deconvolving the blurred image.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified view of a scene, an image apparatus having features of the present invention, and a blurred image;

FIG. 2 is a simplified front perspective view of the image apparatus of FIG. 1;

FIG. 3A illustrates a pair of artificially blurred first test images;

FIG. 3B illustrates a pair of artificially blurred second test images;

FIG. 3C illustrates a pair of artificially blurred third test images;

FIG. 3D illustrates a pair of artificially blurred fourth test images;

FIG. 4 illustrates the blurred image, and an adjusted image;

FIG. 5 is a flow chart that illustrates one method for estimating blur direction; and

FIG. 6 illustrates another embodiment of a system having features of the present invention.

### DESCRIPTION

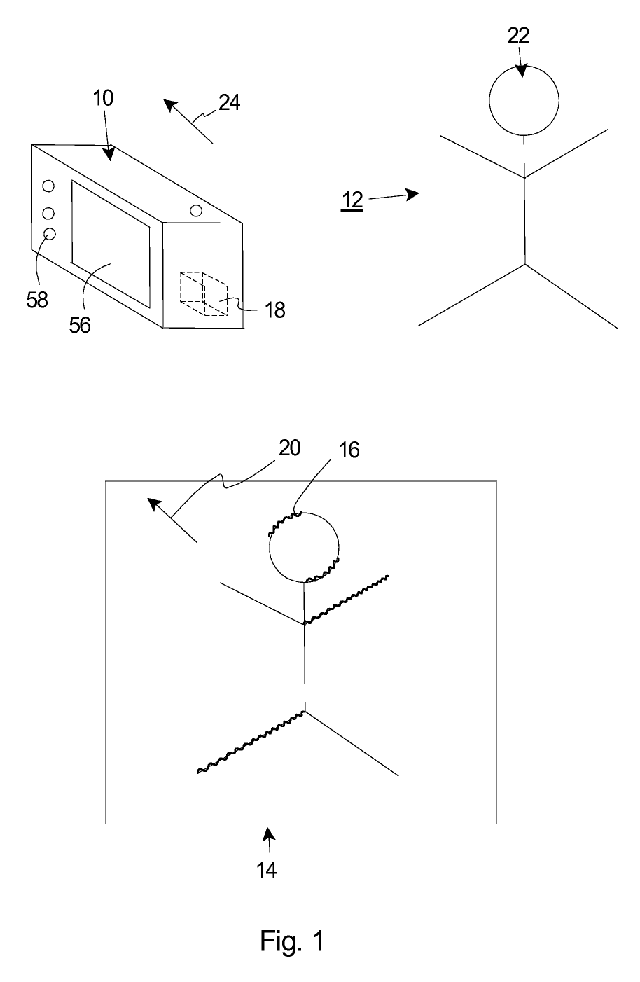

FIG. 1 is a simplified perspective illustration of an image apparatus 10 having features of the present invention, and a scene 12. The image apparatus 10 captures a raw captured image 14 (illustrated away from the image apparatus 10) that can be blurred 16 (illustrated as a thicker, wavy line). In one embodiment, the image apparatus 10 includes a control system 18 (illustrated in phantom) that uses a unique method for estimating an unknown blur direction 20 (illustrated as an arrow) of motion blur 16 in the blurred image 14. In certain embodiments, with information regarding the blur direction 20 in the blurred image 14, the amount of blur 16 in the image 14 can be accurately reduced.

As an overview, in one embodiment, the proposed method for estimating the prevailing blur direction 20 of motion blur 16 is based on the concepts that (i) when artificial blur is applied to the blurred image 14 in a test direction that is similar to the blur direction 20, the difference in the image appearance is relatively small, and minimum changes exist between the additionally blurred image and the original image 14; and (ii) when artificial blur is applied to the blurred image 14 in a test direction that is perpendicular to the blur direction 20, the difference in the image appearance is relatively large, and maximum changes exist between the additionally blurred image and the original image 14.

The type of scene 12 captured by the image apparatus 10 can vary. For example, the scene 12 can include one or more objects 22, e.g. animals, plants, mammals, and/or environments. For simplicity, in FIG. 1, the scene 12 is illustrated as including one object 22. Alternatively, the scene 12 can include more than one object 22. In FIG. 1, the object 22 is a simplified stick figure of a person.

It should be noted that movement of the image apparatus 10 and/or movement of the object 22 in the scene 12 during the capturing of the blurred image 14 can cause motion blur 16 in the blurred image 14 that is mainly in the blur direction 20. For example, in FIG. 1, the image apparatus 10 was moved along a motion direction 24 (illustrated as an arrow) during the exposure time while capturing the blurred image 14. As a result thereof, the blurred image 14 has blur 16 in the blur direction 20 that corresponds to the motion direction 24.

It should be noted that the motion direction 24 is usually random and can be different than that illustrated in FIG. 1. For example, the motion direction 24 can be up and down. This motion can be non-uniform linear motion. Alternatively, the motion can be non-linear.

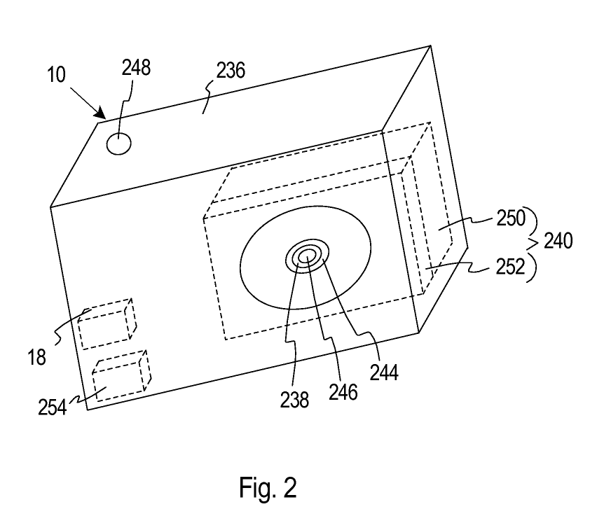

FIG. 2 illustrates a simplified, front perspective view of one, non-exclusive embodiment of the image apparatus 10. In this embodiment, the image apparatus 10 is a digital camera, and includes an apparatus frame 236, an optical assembly 238, and a capturing system 240 (illustrated as a box in phantom), in addition to the control system 18 (illustrated as a box in phantom). The design of these components can be varied to suit the design requirements and type of image apparatus 10. Further, the image apparatus 10 could be designed without one or more of these components. Additionally or alternatively, the image apparatus 10 can be designed to capture a video of the scene 12.

The apparatus frame 236 can be rigid and support at least some of the other components of the image apparatus 10. In one embodiment, the apparatus frame 236 includes a generally rectangular shaped hollow body that forms a cavity that receives and retains at least some of the other components of the camera.

The apparatus frame 236 can include an aperture 244 and a shutter mechanism 246 that work together to control the amount of light that reaches the capturing system 240. The shutter mechanism 246 can be activated by a shutter button 248. The shutter mechanism 246 can include a pair of blinds (sometimes referred to as “blades”) that work in conjunction with each other to allow the light to be focused on the capturing system 240 for a certain amount of time. Alternatively, for example, the shutter mechanism 246 can be all electronic and contain no moving parts. For example, an electronic capturing system 240 can have a capture time controlled electronically to emulate the functionality of the blinds.

The optical assembly 238 can include a single lens or a combination of lenses that work in conjunction with each other to focus light onto the capturing system 240. In one embodiment, the image apparatus 10 includes an autofocus assembly (not shown) including one or more lens movers that move one or more lenses of the optical assembly 238 in or out until the sharpest possible image of the subject is received by the capturing system 240.

The capturing system 240 captures information for the raw blurred image 14 (illustrated in FIG. 1). The design of the capturing system 240 can vary according to the type of image apparatus 10. For a digital type camera, the capturing system 240 includes an image sensor 250 (illustrated in phantom), a filter assembly 252 (illustrated in phantom), and a storage system 254 (illustrated in phantom).

The image sensor 250 receives the light that passes through the aperture 244 and converts the light into electricity. One non-exclusive example of an image sensor 250 for digital cameras is known as a charge coupled device (“CCD”). An alternative image sensor 250 that may be employed in digital cameras uses complementary metal oxide semiconductor (“CMOS”) technology.

The image sensor 250, by itself, produces a grayscale image as it only keeps track of the total quantity of the light that strikes the surface of the image sensor 250. Accordingly, in order to produce a full color image, the filter assembly 252 is generally used to capture the colors of the image.

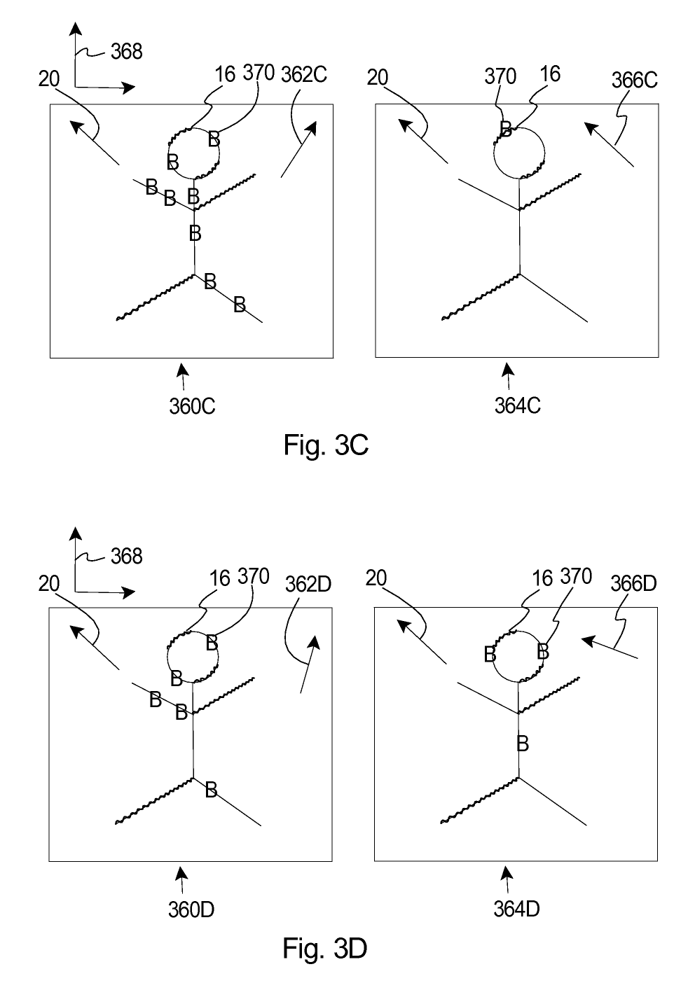

The storage system 254 stores the various raw images 14 (illustrated in FIG. 1) and/or one or more adjusted images 455 (illustrated in FIG. 4) before these images are ultimately printed out, deleted, transferred or downloaded to an auxiliary storage system or a printer. The storage system 254 can be fixedly or removable coupled to the apparatus frame 236. Non-exclusive examples of suitable storage systems 254 include flash memory, a floppy disk, a hard disk, or a writeable CD or DVD.

The control system 18 is electrically connected to and controls the operation of the electrical components of the image apparatus 10. The control system 18 can include one or more processors and circuits, and the control system 18 can be programmed to perform one or more of the functions described herein. In FIG. 2, the control system 18 is secured to the apparatus frame 236 and the rest of the components of the image apparatus 10. Further, the control system 18 is positioned within the apparatus frame 236.

In certain embodiments, the control system 18 includes software that estimates the blur direction 20 of motion blur 16 in the blurred image 14. Further, the control system 18 can include software that reduces the blur 16 in the blurred image 14 to provide an adjusted image 455 (illustrated in FIG. 4).

Referring back to FIG. 1, the image apparatus 10 includes an image display 56 that displays the blurred image 14 and/or the adjusted images 455. With this design, the user can decide which images 14, 455 should be stored and which images 14, 455 should be deleted. In FIG. 1, the image display 56 is fixedly mounted to the rest of the image apparatus 10. Alternatively, the image display 56 can be secured with a hinge mounting system (not shown) that enables the display 56 to be pivoted. One non-exclusive example of an image display 56 includes an LCD screen.

Further, the image display 56 can display other information that can be used to control the functions of the image apparatus 10.

Moreover, the image apparatus 10 can include one or more control switches 58 electrically connected to the control system 18 that allows the user to control the functions of the image apparatus 10. For example, one or more of the control switches 58 can be used to selectively switch the image apparatus 10 to the blur direction 20 estimation processes and/or deblurring processes disclosed herein.

As provided herein, in one embodiment, the motion blur of the captured image 14 (illustrated in FIG. 1) is assumed to be equal to H θ, where H θ is a blur filter, H is a notation for a motion blurred filter, and theta (“θ”) is the motion blur direction.

In one embodiment, the present invention applies additional blur, B α, in which B is a notation for another blur filter, and alpha (“α”) is the motion blur direction.

With this design, an overall blur (“Pall”) can be expressed as follows:

Pall=Bα*Hθ Equation 1

As provided herein, if the direction alpha of the additional blur coincides with the direction theta of the original blur, then the overall blur will undergo minimum change. Basically, the blur shape will not change, only the blur weight will change.

Alternatively, if the direction alpha of the additional blur is different than the direction theta of the original blur, then the overall blur will change in shape and blur weight. For example, if the additional blur direction alpha is perpendicular to original blur direction theta (i.e., α=θ+90), then the overall blur (“Pall”) will undergo maximum changes in shape and weight compared to other additional blur directions.

In certain embodiments, the present invention works on the premise (i) that the correct estimated alpha will result in minimum changes between the additionally blurred image to the original given blurred image, and (ii) the direction perpendicular to the correct estimation will result in maximum changes between the additionally blurred image to the original given blurred image.

This can be express in equations 2 and 3 below:

min α∥Bα|(x,y)−(x,y)∥ Equation 2

max α+90∥Bα+90|(x,y)−|(x,y)∥ Equation 3

where |(x,y) is the original given blurred image.

The present invention proposes to use both the minimum and maximum information to increase the accuracy of the motion blur direction estimation.

A blur difference “f(α)” between an artificially blurred image (blurred with blur filter B and at an angle of alpha) and the original image can be defined as follows:

f(α)=|Bα|(x,y)−|(x,y)|. Equation 4

Further, a perpendicular blur difference “f(α+90)” between an artificially blurred image (blurred with blur filter B and at an angle of alpha plus ninety degrees) and the original image can be defined as follows:

f(α+90)=|Bα+90 |(x,y)−|(x,y)|. Equation 5

Moreover, a pair difference “PD” between the blur difference “f(α)” and the perpendicular blur difference “f(α+90)” can be expressed as follows:

PD=|f(α+90)−f(α)| Equation 6

As α moves away from the correct blur direction, f(α) will increase accordingly, and f(α+90) will decrease accordingly, therefore the difference PD between them will be smaller and smaller.

The pair difference “|f(α+90)−f(α) |” should be a sharper curve than the blur difference “f(α)” as it roughly doubles the differences, therefore it is easy and more robust to find the maximum. As a result thereof, the present method can lead to more accurate blur direction estimation and more efficient implementation. Further, the present invention can require a very short testing blur size (e.g. length=3) to achieve good results because of the use of both the minimum and maximum information. This saves computation and allows for fast implementation.

The results maybe especially good if the original blur size is comparably bigger than the test blur size.

To estimate the blur direction, the present invention selects a plurality of sample angles α that are in the range of zero to ninety degrees [0 90]. Subsequently, (i) linear blur B is applied at each sample angle α to the given blurred image |(x,y) to get B α |(x,y) for each sample angle, and (ii) linear blur B is applied at each sample angle α+90 to the given blurred image |(x,y) to get B α+90 |(x,y) for each sample angle.

Next, the pair difference for each pair of angles (αα+90) is determined to the maximum pair difference PD=|f(α+90)−f(α) |. Subsequently, after the maximum pair difference is determined, the estimated blur direction is: α, if f(α)<f(α+90) or a+90, if f(α+90)<f(α).

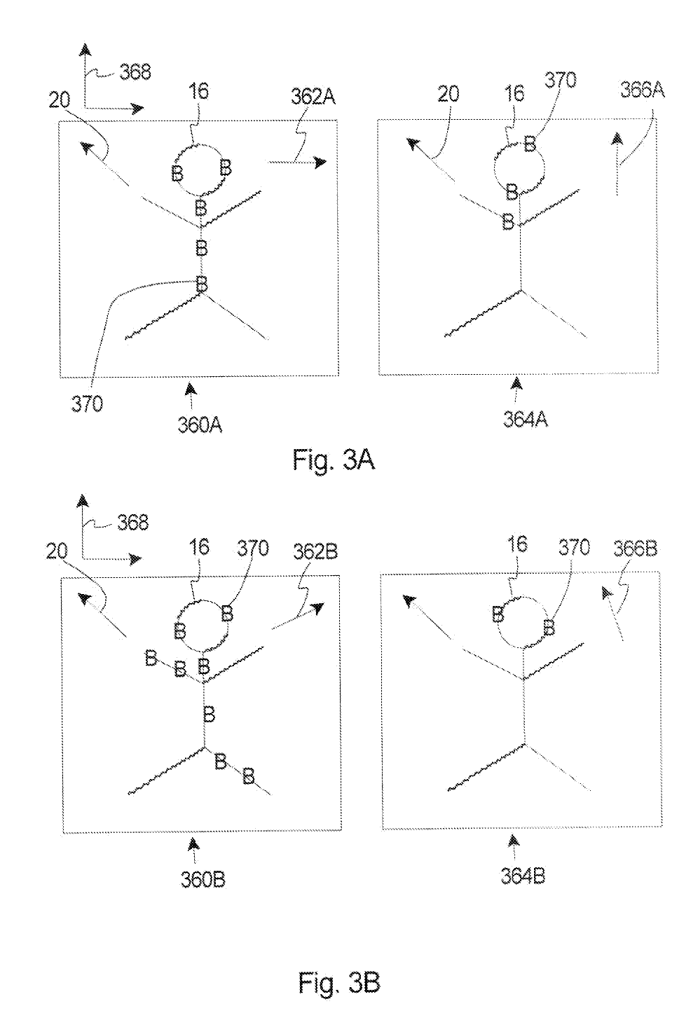

The present methods can better understood in conjunction with the discussion of FIGS. 3A-3D. More specifically, FIG. 3A illustrates (i) an artificially blurred first test image 360A that is created by blurring the blurred captured image 14 (illustrated in FIG. 1) along a first test direction 362A (illustrated as an arrow); and (ii) an artificially blurred first perpendicular test image 364A that is created by blurring the blurred captured image 14 along a first perpendicular test direction 366A (illustrated as an arrow). In an orientation system 368 illustrated in FIG. 3A, the first test direction 362A is approximately zero (0) degrees, and the first perpendicular test direction 366A is approximately ninety (90) degrees. Thus, the first perpendicular test direction 366A is perpendicular to the first test direction 362A. The first test image 360A and the first perpendicular test image 364A can be collectively referred to as a pair of first test images or a first image pair.

It should be noted that the terms “first”, “second”, “third”, and “fourth” are used merely for convenience and that any of the images can be called the “first”, “second”, “third”, or “fourth”.

Somewhat similarly, FIG. 3B illustrates (i) an artificially blurred second test image 360B that is created by blurring the blurred captured image 14 (illustrated in FIG. 1) along a second test direction 362B (illustrated as an arrow); and (ii) an artificially blurred second perpendicular test image 364B that is created by blurring the blurred captured image 14 along a second perpendicular test direction 366B (illustrated as an arrow). In the orientation system 368 illustrated in FIG. 3B, the second test direction 362B is approximately twenty-five (25) degrees, and the second perpendicular test direction 366B is approximately one hundred and fifteen (115) degrees. Thus, the second perpendicular test direction 366B is perpendicular to the second test direction 362B. The second test image 360B and the second perpendicular test image 364B can be collectively referred to as a pair of second test images or a second image pair.

FIG. 3C illustrates (i) an artificially blurred third test image 360C that is created by blurring the blurred captured image 14 (illustrated in FIG. 1) along a third test direction 362C (illustrated as an arrow); and (ii) an artificially blurred third perpendicular test image 364C that is created by blurring the blurred captured image 14 along a third perpendicular test direction 366C (illustrated as an arrow). In the orientation system 368 illustrated in FIG. 3C, the third test direction 362C is approximately fifty (50) degrees, and the third perpendicular test direction 366C is approximately one hundred and forty (140) degrees. Thus, the third perpendicular test direction 366C is perpendicular to the third test direction 362C. The third test image 360C and the third perpendicular test image 364C can be collectively referred to as a pair of third test images or a third image pair.

FIG. 3D illustrates (i) an artificially blurred fourth test image 360D that is created by blurring the blurred captured image 14 (illustrated in FIG. 1) along a fourth test direction 362D (illustrated as an arrow); and (ii) an artificially blurred fourth perpendicular test image 364D that is created by blurring the blurred captured image 14 along a fourth perpendicular test direction 366D (illustrated as an arrow). In the orientation system 368 illustrated in FIG. 3D, the fourth test direction 362D is approximately seventy-five (75) degrees, and the fourth perpendicular test direction 366D is approximately one hundred and sixty-five (165) degrees. Thus, the fourth perpendicular test direction 366D is perpendicular to the fourth test direction 362D. The fourth test image 360A and the fourth perpendicular test image 364A can be collectively referred to as a pair of fourth test images or a fourth image pair.

Further, FIGS. 3A-3D includes the actual blur direction 20 (illustrated as an arrow).

In one embodiment, each of the test images 360A-D, 364A-D is generated by artificially blurring the captured image 14 in the respective test direction 362A-D, 366A-D. For example, to generate the first test image 360A, a convolution operation is performed on the blurred image 14 with a matrix representing Point Spread Function (“PSF”) corresponding to blurring in the first test direction 362A (horizontal direction). Each of the test images 360A-D, 364A-D can be generated using the convolution operation in a somewhat similar fashion.

In FIGS. 3A-3D, the original blur 16 is again illustrated with the thicker, wavy line. Further, in FIGS. 3A-3D, each of the test images 360A-D, 362A-D includes an additional artificial blur 370 represented as “B's”.

As provided herein, when more blur is applied to the blurred image 14 in a test direction 362A-D, 366A-D that is similar to the original blur direction 20, the difference in the image appearance is relatively small and the amount of additional artificial blur 370 is relatively small. However, when more blur is applied to the blurred image 14 in a test direction 362A-D, 366A-D that is very different (e.g. perpendicular) to the blur direction 20, the difference in the image appearance is relatively large and the amount of additional artificial blur 370 is relatively large.

As the test direction 362A-D, 366A-D moves away from the original blur direction 20, the amount of blur will increase accordingly until the test direction 362A-D, 366A-D is approximately perpendicular to the original blur direction 20. In the example illustrated in FIGS. 3A-3D, the original blur direction 20 is approximately at one hundred and forty (140) degrees relative to the orientation system 368. Further, in FIGS. 3A-3D, the third perpendicular test image 364C has the least amount of additional blurring 370 while the third test image 360C has the largest amount of additional blurring 370. This is because the third perpendicular test direction 366C is equal to the original blur direction 20, and the third test direction 362C is perpendicular to the original blur direction 20.

As provided herein, the control system 18 (illustrated in FIG. 1) computes a pair difference for each image pair. For example, to compute the pair difference for the first image pair, the control system 18 (i) compares the first test image 360A with the blurred image 14 to determine a first blur difference between the first test image 360A and the blurred image 14; (ii) compares the first perpendicular test image 364A with the blurred image 14 to determine a first perpendicular blur difference between the first perpendicular test image 364A and the blurred image 14. Next, the control system 18 calculates a first pair difference between the first blur difference and the first perpendicular blur difference.

Similarly, to compute the pair difference for the second image pair, the control system 18 (i) compares the second test image 360B with the blurred image 14 to determine a second blur difference between the second test image 360B and the blurred image 14; (ii) compares the second perpendicular test image 364B with the blurred image 14 to determine a second perpendicular blur difference between the second perpendicular test image 364B and the blurred image 14. Next, the control system 18 calculates a second pair difference between the second blur difference and the second perpendicular blur difference.

Further, to compute the pair difference for the third image pair, the control system 18 (i) compares the third test image 360C with the blurred image 14 to determine a third blur difference between the third test image 360C and the blurred image 14; (ii) compares the third perpendicular test image 364C with the blurred image 14 to determine a third perpendicular blur difference between the third perpendicular test image 364C and the blurred image 14. Next, the control system 18 calculates a third pair difference between the third blur difference and the third perpendicular blur difference.

Moreover, to compute the pair difference for the fourth image pair, the control system 18 (i) compares the fourth test image 360D with the blurred image 14 to determine a fourth blur difference between the fourth test image 360D and the blurred image 14; (ii) compares the fourth perpendicular test image 364D with the blurred image 14 to determine a fourth perpendicular blur difference between the fourth perpendicular test image 364D and the blurred image 14. Next, the control system 18 calculates a fourth pair difference between the fourth blur difference and the fourth perpendicular blur difference.

Further, the control system 18 compares the pair differences for the image pairs and selects the pair difference with the largest value. Subsequently, for the image pair with the largest pair difference, the control system 18 selects the test direction with the smallest blur difference as the estimated blur direction. In the example illustrated in FIGS. 3A-3D, the third pair difference is the largest because the third perpendicular test image 364C has the least amount of additional blurring 370 between the while the third test image 360C has the largest amount of additional blurring 370. Stated in another fashion, the third pair difference is the largest because, the third perpendicular blur difference is relatively small while the third blur difference is relatively large.

After the third test pair is selected by the control system 18, the third perpendicular test direction 366C is selected by the control system 18 as the unknown blur direction because the third perpendicular blur difference is less than the third blur difference.

It should be noted that the difference between what is considered a large blur difference and what is considered a small blur difference will vary according to the content of the image and many other factors, such as size of the image. Also, there is a number of different ways how to measure the difference between two images. The resulting value can be practically any number or designation that can be used to compare the values for the different directions in the same image.

The number of test image pairs used in the estimation and the difference between the test directions 362A-D can vary pursuant to the teachings provided herein. Generally speaking, the accuracy of the estimation can increase as the number of image pairs is increased, but the computational complexity also increases as the number of image pairs created is increased.

In FIGS. 3A-3D, only four image pairs are provided for simplicity and the test directions 362A-D, 366A-D are oriented approximately twenty-five degrees apart. In alternative non-exclusive embodiments, ten, twenty, forty-five, ninety, or one hundred and eighty test images can be generated, and the test directions can be spaced apart approximately eighteen, nine, six, four, two, or one degrees.

Alternatively, a coarse-to-fine approach in the sampling angles can be used. In this example, coarse sampling (e.g. every ten degree) is used by the control system to obtain the rough direction. Subsequently, near the rough direction, dense sampling (e.g. every one degree) is used by the control system to obtain the fine estimated blur direction.

In certain embodiments, the present invention can be applied to either a monochrome image or a color image (convert color to grayscale). Also, as provided herein, the blur direction estimation can be applied to processed images, or the blur direction estimation can also be implemented as a part of image processing pipeline.

In one non-exclusive example, for a color image, the blur differences can be calculated with the control system 18 (illustrated in FIG. 1) by comparing the brightness value at each pixel in each channel matrix for the blurred image 14 to the brightness value at each pixel in each channel matrix in the respective test image. In this example, the blur difference can be calculated for each channel, and values averaged to possibly get a more robust blur direction estimate. However, this method can be computationally very expensive.

In another example, a color image would first be converted to black and white, for example by taking the average of the three color channels, or by selecting one of the channels (usually the green one is used). Next, the method is applied to the resulting black and white image.

Alternatively or additionally, one or more of the blur difference values can be generated by interpolation information from previously generated blur difference values for test images that were generated using the convolution operation. In one non-exclusive embodiment, test images are generated at five degree intervals using the convolution method. Subsequently, additional blur difference values can be generated at one degree increments between the previously generated blur difference values for the test images using interpolation.

FIG. 4 illustrates the blurred image 14, and the adjusted image 455. In this embodiment, after the blur direction 20 is estimated, the control system 18 (illustrated in FIG. 1) can perform one or more deblurring techniques to target the blur 16 in the blurred image 14 to provide the adjusted image 455. For example, accelerated Lucy-Richardson deconvolution can be performed on the blurred image 14 to provide the adjusted image 455. In this example, the adjusted image 455 has significantly less blur 16 than the capture image 14.

To deblur an image, you have to know the PSF (which is the function that describes how the image is blurred). In case of a motion blur, an assumption is often made that the motion is uniform linear motion (in practice it works only for relatively small blurs, though). In that case, to find the PSF you need to estimate blur direction and blur length. The present invention deals with determining the direction of motion blur. A separate method may be necessary to estimate blur length.

So called “blind deconvolution methods” assume that the PSF is unknown and they attempt both to find PSF and to produce a deblurred image at the same time. These methods are typically iterative methods, they require some initial guess for PSF, and this initial guess needs to be close enough to the real PSF for the method to be successful. Knowing the blur direction can help to generate a good initial guess.

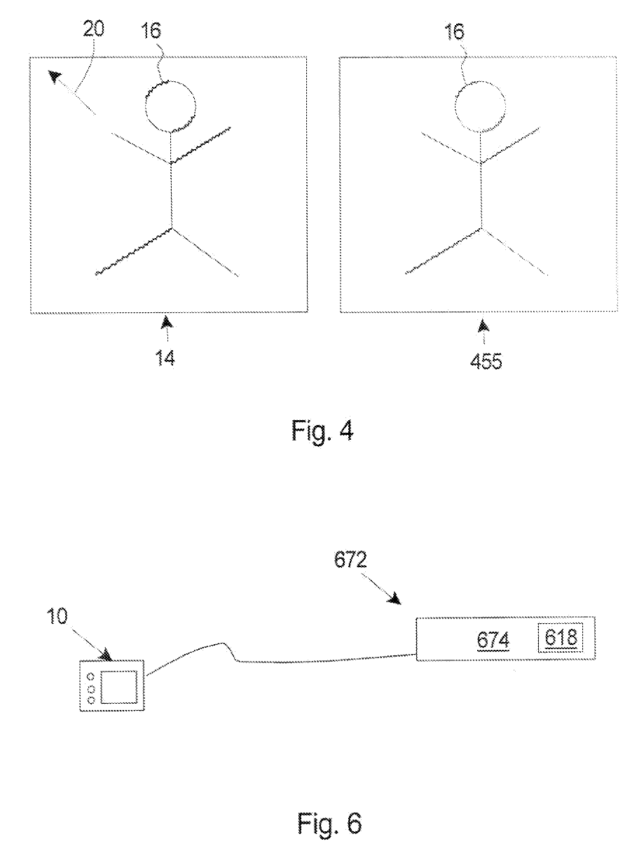

FIG. 5 is a flow chart that illustrates one method for estimating a direction of motion blur. First a step 510, the motion blurred image is captured by the camera. Subsequently, at step 512, the control system generates a plurality of artificially blurred image pairs. Next, at step 514, the control system compares each of the artificially blurred images to the original blurred image to generate a blur difference for each artificially blurred image. Subsequently, at step 516, the control system compares the blur differences for each image pair to determine a pair difference for each image pair. Next, at step 518, the control system selects the image pair with the greatest pair difference as the image pair that includes the estimated blur direction. Subsequently, at step 520, the control system compares the blur differences for the selected image pair, and the control system identifies the blur direction of the selected image pair that has the lowest blur difference. Finally, at step 522, the control system deblurs the original captured image to generate the adjusted image.

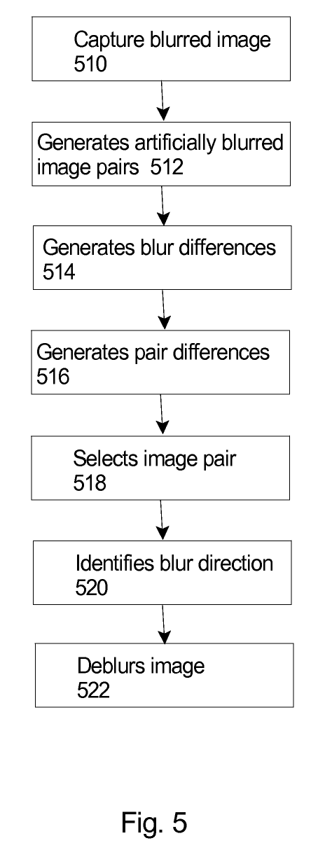

FIG. 6 illustrates another embodiment of an estimating system 672 having features of the present invention. In this embodiment, the image apparatus 10 again captures the blurred image 14 (illustrated in FIG. 1). However, in this embodiment, the blurred image 14 is transferred to a computer 674 (e.g. a personal computer) that includes a computer control system 618 (illustrated in phantom) that uses the estimation method disclosed herein to estimate the blur direction. Further, the computer control system 618 can deblur the blurred image 14 and provide the adjusted image 455 (illustrated in FIG. 4).

While the current invention is disclosed in detail herein, it is to be understood that it is merely illustrative of the presently preferred embodiments of the invention and that no limitations are intended to the details of construction or design herein shown other than as described in the appended claims.

What is claimed is:

1. A method for estimating a blur direction of motion blur in a blurred image, the method comprising the steps of:
blurring the blurred image along a first test direction to create an artificially blurred first test image;
blurring the blurred image along a first perpendicular test direction to create an artificially blurred first perpendicular test image, the first perpendicular test direction being substantially perpendicular to the first test direction;
comparing the first test image with the blurred image to determine a first blur difference between the first test image and the blurred image;
comparing the first perpendicular test image with the blurred image to determine a first perpendicular blur difference between the first perpendicular test image and the blurred image; and
determining a first pair difference between the first blur difference and the first perpendicular blur difference.

2. The method of claim 1 further comprising the steps of:
blurring the blurred image along a second test direction to create an artificially blurred second test image, the second test direction being different than the first test direction;
blurring the blurred image along a second perpendicular test direction to create an artificially blurred second perpendicular test image, the second perpendicular test direction being substantially perpendicular to the second test direction;
comparing the second test image with the blurred image to determine a second blur difference between the second test image and the blurred image;
comparing the second perpendicular test image with the blurred image to determine a second perpendicular blur difference between the second perpendicular test image and the blurred image; and
determining a second pair difference between the second blur difference and the second perpendicular blur difference.

3. The method of claim 2 further comprising the step of comparing the first pair difference with the second pair difference to estimate the blur direction.

4. The method of claim 3 further comprising the step of selecting one of the first test directions as the blur direction in the event the first pair difference is greater than the second pair difference.

5. The method of claim 2 further comprising the steps of:
blurring the blurred image along a third test direction to create an artificially blurred third test image, the third test direction being different than the first test direction and the second test direction;
blurring the blurred image along a third perpendicular test direction to create an artificially blurred third perpendicular test image, the third perpendicular test direction being substantially perpendicular to the third test direction;
comparing the third test image with the blurred image to determine a third blur difference between the third test image and the blurred image;
comparing the third perpendicular test image with the blurred image to determine a third perpendicular blur difference between the third perpendicular test image and the blurred image; and
determining a third pair difference between the third blur difference and the third perpendicular blur difference.

6. The method of claim 5 further comprising the step of comparing the first pair difference with the second pair difference and the third pair different to estimate the blur direction.

7. The method of claim 6 further comprising the step of selecting one of the first test directions as the blur direction in the event the first pair difference is greater than the second pair difference and the third pair difference.

8. The method of claim 1 further comprising the step of deconvolving the blurred image to provide an adjusted image.

9. A device for estimating a blur direction of motion blur in a blurred image, the device comprising:
a control system that (i) blurs the blurred image along a first test direction to create an artificially blurred first test image; (ii) blurs the blurred image along a first perpendicular test direction to create an artificially blurred first perpendicular test image, the first perpendicular test direction being substantially perpendicular to the first test direction; (iii) compares the first test image with the blurred image to determine a first blur difference between the first test image and the blurred image; (iv) compares the first perpendicular test image with the blurred image to determine a first perpendicular blur difference between the first perpendicular test image and the blurred image; and (v) determines a first pair difference between the first blur difference and the first perpendicular blur difference.

10. The device of claim 9 wherein the control system (i) blurs the blurred image along a second test direction to create an artificially blurred second test image, the second test direction being different than the first test direction; (ii) blurs the blurred image along a second perpendicular test direction to create an artificially blurred second perpendicular test image, the second perpendicular test direction being substantially perpendicular to the second test direction; (iii) compares the second test image with the blurred image to determine a second blur difference between the second test image and the blurred image; (iv) compares the second perpendicular test image with the blurred image to determine a second perpendicular blur difference between the second perpendicular test image and the blurred image; and (v) determines a second pair difference between the second blur difference and the second perpendicular blur difference.

11. The device of claim 10 wherein the control system compares the first pair difference with the second pair difference to estimate the blur direction.

12. The device of claim 11 wherein the control system selects one of the first test directions as the blur direction in the event the first pair difference is greater than the second pair difference.

13. The device of claim 10 wherein the control system (i) blurs the blurred image along a third test direction to create an artificially blurred third test image, the third test direction being different than the first test direction and the second test direction; (ii) blurs the blurred image along a third perpendicular test direction to create an artificially blurred third perpendicular test image, the third perpendicular test direction being substantially perpendicular to the third test direction; (iii) compares the third test image with the blurred image to determine a third blur difference between the third test image and the blurred image; (iv) compares the third perpendicular test image with the blurred image to determine a third perpendicular blur difference between the third perpendicular test image and the blurred image; and (v) determines a third pair difference between the third blur difference and the third perpendicular blur difference.

14. The device of claim 13 wherein the control system compares the first pair difference with the second pair difference and the third pair different to estimate the blur direction.

15. The device of claim 14 wherein the control system selects one of the first test directions as the blur direction in the event the first pair difference is greater than the second pair difference and the third pair difference.

16. The device of claim 9 wherein the control system deconvolves the blurred image to provide an adjusted image.

17. The device of claim 9 further comprising a capturing system for capturing the blurred image.

18. A method for estimating a blur direction of motion blur in a blurred image, the method comprising the steps of:
creating a first pair of artificially blurred images by blurring the blurred image along a first test direction and along a first perpendicular test direction that is substantially perpendicular to the first test direction; and
determining a first pair difference between the first pair of artificially blurred images.

19. The method of claim 18 wherein the step of determining a first pair difference includes the steps of (i) comparing each artificially blurred images to the blurred image to create a blur difference for each artificially blurred image; and (ii) comparing the blur differences for the artificially blurred images.

20. The method of claim 18 further comprising the step of (i) creating a second pair of artificially blurred images by blurring the blurred image along a second test direction and along a second perpendicular test direction that is substantially perpendicular to the second test direction; and (ii) determining a second pair difference between the second pair of artificially blurred images.

21. The method of claim 20 further comprising the step of comparing the first pair difference with the second pair difference to estimate the blur direction.

22. The method of claim 21 further comprising the step of selecting one of the first test directions as the blur direction in the event the first pair difference is greater than the second pair difference.
